(19) United States
(12) Patent Application Publication
(10) Pub. No.: US 2019/0050891 A1
(43) Pub. Date: Feb. 14, 2019

(54) METHOD AND APPARATUS FOR PROVIDING INTERNET ADVERTISING

(71) Applicant: A1 Media Group Co., Ltd., Tokyo (JP)

(72) Inventor: Joon Ho CHUNG, Rochester, NY (US)

(21) Appl. No.: 15/774,429

(22) PCT Filed: Aug. 20, 2015
(86) PCT No.: PCT/KR2015/008681

§ 371 Date: May 8, 2018

(30) Foreign Application Priority Data
Jul. 1, 2015 (KR) 10-2015-0094346

(51) Int. Cl. G06Q 30/02

(52) U.S. Cl. CPC G06Q 30/0243; G06Q 30/0277; G06Q 30/0255

(57) ABSTRACT

An apparatus and a method of providing Internet advertising according to an exemplary embodiment is connected with a medium, an advertiser server, and a user terminal via a wired/wireless communication network, and includes: an access information collecting unit which collects access information about a user for the medium; a movement information collecting unit which collects movement information about the user for one or more advertising pages provided from the advertiser server; a user analyzing unit which analyses a tendency of the user based on the access information and the movement information; an advertising page transmission rate calculating unit which calculates an advertising page transmission rate based on a result of the analysis of the tendency of the user; and an advertising transmitting unit which transmits the one or more advertising pages to the user terminal based on the advertising page transmission rate.

### TECHNICAL FIELD

The present invention relates to an apparatus and a method of providing Internet advertising.

### BACKGROUND ART

With the development of various wireless devices and a network infrastructure, online accessibility is considerably improved and off-line advertising frequency is decreased.

Internet advertising means advertising utilizing an advantage of a medium, the Internet, and provides advertising via an Internet webpage by using a computer or a portable wireless device, thereby maximizing an advertising effect with minimum cost without a limit of time, a place, and a target.

Further, it is easy to produce Internet advertising according to a characteristic of an advertising target in that an advertising publisher is capable of setting a method (exposing the Internet advertising in a part or entirety of a web page) and a form of exposing Internet advertising via a web page (by using one or more among a character, an image, a video, and a sound), and it is possible to produce various forms of Internet advertising for attracting interests of consumers.

Recently, in order to improve an Internet advertising effect, information about consumers is analyzed and Internet advertising is provided according to a result of the analysis. However, the method provides Internet advertising by individually collecting and analyzing, by an Internet advertising medium or an advertiser's web page, consumer information. Accordingly, there is a limit in recognizing an interest field of a consumer and it is difficult to provide Internet advertising optimized to the interest field of the consumer.

### DISCLOSURE

### Technical Problem

The present invention has been made in an effort to provide advertising and an advertising page based on user information for Internet media advertising and an advertising page.

The exemplary embodiment of the present invention may be used for achieving other objects that are not particularly mentioned, in addition to the foregoing object.

### Technical Solution

An exemplary embodiment of the present invention provides an apparatus for providing Internet advertising, the apparatus being connected with a medium, an advertiser server, and a user terminal via a wired/wireless communication network, and including: an access information collecting unit which collects access information about a user for the medium; a movement information collecting unit which collects movement information about the user for one or more advertising pages provided from the advertiser server; a user analyzing unit which analyses a tendency of the user based on the access information and the movement information; an advertising page transmission rate calculating unit which calculates an advertising page transmission rate based on a result of the analysis of the tendency of the user; and an advertising transmitting unit which transmits the one or more advertising pages to the user terminal based on the advertising page transmission rate.

The apparatus may further include a user determining unit which searches for an access history of the user for the medium based on the access information, and determines that the user wants media advertising when the access history of the user for the medium is present, in which the advertising transmitting unit may transmit the media advertising when the user determining unit determines that the user wants the media advertising.

The access information may include one or more elements of information among a cookie, an Internet protocol (IP), and a user terminal identification (ID), and the movement information may include one or more elements of information about a view order within the one or more advertising pages, the number of times of view based on an advertising page, a view time zone, and a view continuous time.

The result of the analysis of the tendency of the user may include one or more of an action of the user, an access keyword, an advertising effect based on an advertising page viewed by the user, an advertising page having the highest advertising effect, and an advertising page having the lowest advertising effect.

Another exemplary embodiment of the present invention provides a method of providing Internet advertising, the method being connected with a medium and an advertiser server via a wired/wireless communication network, and including: collecting access information about a user for the medium; searching an access history of the user for the medium based on the access information, and determining that the user wants media advertising when the access history of the user for the medium is present; and transmitting the media advertising when it is determined that the user wants the media advertising in the determining of the user.

Still another exemplary embodiment of the present invention provides a method of providing Internet advertising, the method being connected with a medium, an advertiser server, and a user terminal via a wired/wireless communication network, and including: collecting access information about a user for the medium; collecting movement information about the user for one or more advertising pages provided from the advertiser server; analyzing a tendency of the user based on the access information and the movement information; calculating an advertising page transmission rate based on a result of the analysis of the tendency of the user; and transmitting the one or more advertising pages to the user terminal based on the advertising page transmission rate.

The method may further include: searching for an access history of the user for the medium based on the access information; and determining that the user wants media advertising when the access history of the user for the medium is present, in which in the determining of the user, the media advertising may be transmitted when it is determined that the user wants the media advertising.

The access information may include one or more elements of information among a cookie, an Internet protocol (IP), and a user terminal identification (ID), and the movement information may include one or more elements of information about a view order within the one or more advertising pages, the number of times of view based on an advertising page, a view time zone, and a view continuous time.

The result of the analysis of the tendency of the user may include one or more of an action of the user, an access keyword, an advertising effect based on an advertising page viewed by the user, an advertising page having the highest advertising effect, and an advertising page having the lowest advertising effect.

### Advantageous Effects

According to the exemplary embodiment of the present invention, it is possible to provide advertising customized to a user, thereby improving advertising efficiency.

### DESCRIPTION OF THE DRAWINGS

FIG. 1 is a diagram illustrating an Internet advertising providing apparatus according to an exemplary embodiment of the present invention.

FIG. 2 is a diagram illustrating a media advertising providing method according to an exemplary embodiment of the present invention.

FIG. 3 is a diagram illustrating an advertising page providing method according to an exemplary embodiment of the present invention.

FIG. 4 is a diagram illustrating an example of access information and movement information according to an exemplary embodiment of the present invention.

FIG. 5 is a diagram illustrating an example of combined information according to an exemplary embodiment of the present invention.

FIG. 6 is an example of an advertising page transmission rate according to an exemplary embodiment of the present invention.

### MODE FOR INVENTION

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification. Further, a detailed description of the widely known technology will be omitted.

In the present specification, unless explicitly described to the contrary, the word “comprise” and variations such as “comprises” or “comprising”, will be understood to imply the inclusion of stated elements but not the exclusion of any other elements. In addition, the terms “-unit”, “module”, and the like described in the specification mean units for processing at least one function and operation and can be implemented by hardware components or software components and combinations thereof.

In the present specification, a “medium” means a web site, for example, a search site or a shopping mall, providing digital contents via the Internet.

In the present specification, “media advertising” means advertising, for example, a banner, displayed when a user accesses a medium.

In the present specification, an “advertising page’ is provided by an advertiser and includes information about a product or a service, and is a web page provided to a user when the user accesses media advertising. For example, the advertising page is a landing page.

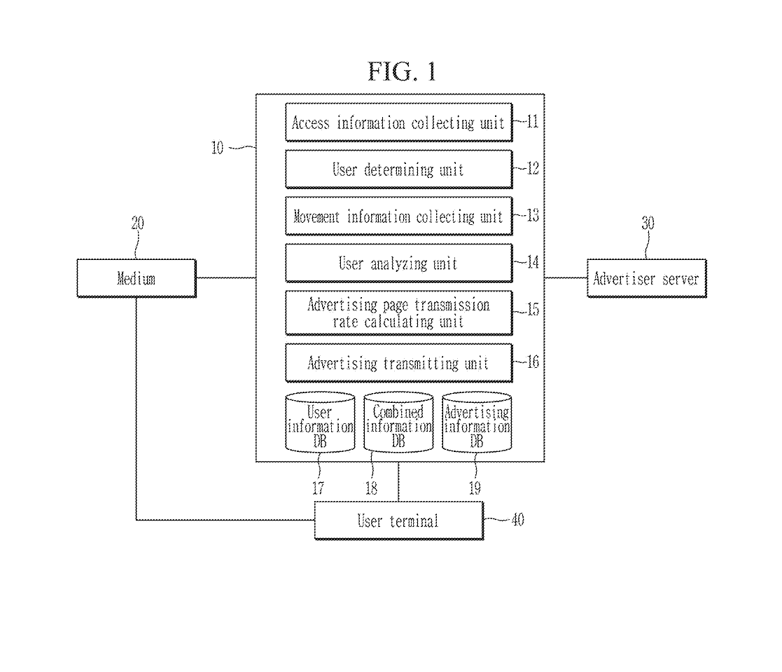

FIG. 1 is a diagram illustrating an Internet advertising providing apparatus according to an exemplary embodiment of the present invention.

An Internet advertising providing apparatus 10 of FIG. 1 is connected with a medium 20 and an advertiser server 30 via a wired/wireless communication network, and is connected with a user terminal 40 via a wired/wireless communication network. In this case, the medium 20, the advertiser server 30, and the user terminal 40 of FIG. 1 may include one or more medium 20, one or more advertiser servers 30, and one or more user terminals 40, respectively.

The Internet advertising providing apparatus 10 of FIG. 1 includes an access information collecting unit 11, a user determining unit 12, a movement information collecting unit 13, a user analyzing unit 14, an advertising page transmission rate calculating unit 15, an advertising transmitting unit 16, a user information database (hereinafter, referred to as a “user information DB”) 17, a combined information database (hereinafter, referred to as a “combined information DB”) 18, and an advertising information database (hereinafter, referred to as an “advertising information DB”) 19.

The access information collecting unit 11 collects user-related information (hereinafter, referred to as “user access information) generated when a user accesses the medium 20 via the user terminal 40 and stores the collected user-related information in the user information DB 17. Further, the access information collecting unit 11 collects user access information at the time at which a specific user accesses a specific Internet medium during an execution of an advertising campaign, and stores the collected user access information in the user information DB 17. In this case, the user access information includes one or more of cookie information, Internet protocol (IP) information, and user terminal identification (ID) information.

The user determining unit 12 determines whether a user accessing the medium 20 wants media advertising based on the user access information stored in the user information DB 17. For example, when user access information for a specific Internet medium is present, the user determining unit 12 may determine that the user wants media advertising. Further, the user determining unit 12 searches for an advertising page transmission rate of the user stored in the combined information DB 18.

The movement information collecting unit 13 collects view information (hereinafter, referred to as “user movement information) of the user for the provided advertising page when the user accesses the media advertising via the user terminal 40 and stores the collected view information in the user information DB 17. In this case, the user movement information includes one or more of a view order among the advertising pages, the number of times of view based on an advertising page, a view time zone, and a view continuous time.

The user analyzing unit 14 generates combined information including the user access information collected by the access information collecting unit 11 and the user movement information collected by the movement information collecting unit 13, and stores the generated combined information in the combined information DB 18. Further, the user analyzing unit 14 analyzes a tendency of the user based on the combined information and stores a result of the analysis in the combined information DB 18. Particularly, the result of the analysis of the tendency of the user may include one or more of a user's action, an access keyword, an advertising effect based on an advertising page viewed by the user, an advertising page having the highest advertising effect, and an advertising page having the lowest advertising effect. In this case, the user determining unit 12 may determine whether the user accessing the medium 20 wants media advertising based on the combined information.

The advertising page transmission rate calculating unit 15 calculates an advertising page transmission rate (the number of times of the transmission) for one or more advertising pages provided by the Internet advertising providing apparatus 10 based on the result of the analysis of the tendency of the user analyzing unit 14 and stores the calculated advertising page transmission rate in the combined information DB 18.

The advertising transmitting unit 16 transmits media advertising based on a result of the determination of the user determining unit 12. Further, the advertising transmitting unit 16 transmits an advertising page to the user terminal 40 based on the advertising page transmission rate calculated by the advertising page transmission rate calculating unit 15. Further, when the advertising page transmission rate of the user is present as a result of the search for the advertising page transmission rate in the combined information DB 18 by the user determining unit 12, the advertising transmitting unit 16 transmits an advertising page to the user terminal 40 based on the stored advertising page transmission rate. Particularly, the advertising transmitting unit 16 preferentially transmits an advertising page having a high advertising effect to the user according to the advertising page transmission rate.

When the advertising page transmission rate of the user calculated by the advertising page transmission rate calculating unit 15 is not present, the advertising transmitting unit 16 transmits an advertising page to the user terminal 40 based on an advertising page transmission rate (default value) pre-stored in the combined information DB 18. Particularly, the default value, that is, the transmission rate, is the same based on an advertising page, and thus, the plurality of advertising pages is transmitted to the user terminal 40 by the same number of times.

The user information DB 17 stores the user access information collected by the access information collecting unit 11 and the user movement information collected by the movement information collecting unit 13.

The combined information DB 18 stores the combined information and the user analysis information generated by the user analyzing unit 14, and stores the advertising page transmission rate calculated by the advertising page transmission rate calculating unit 15.

The advertising information DB 19 stores the media advertising provided from the advertiser server 30. Further, the advertising information DB 19 stores a plurality of advertising pages which is provided from the advertiser server 30 and is accessible via the media advertising.

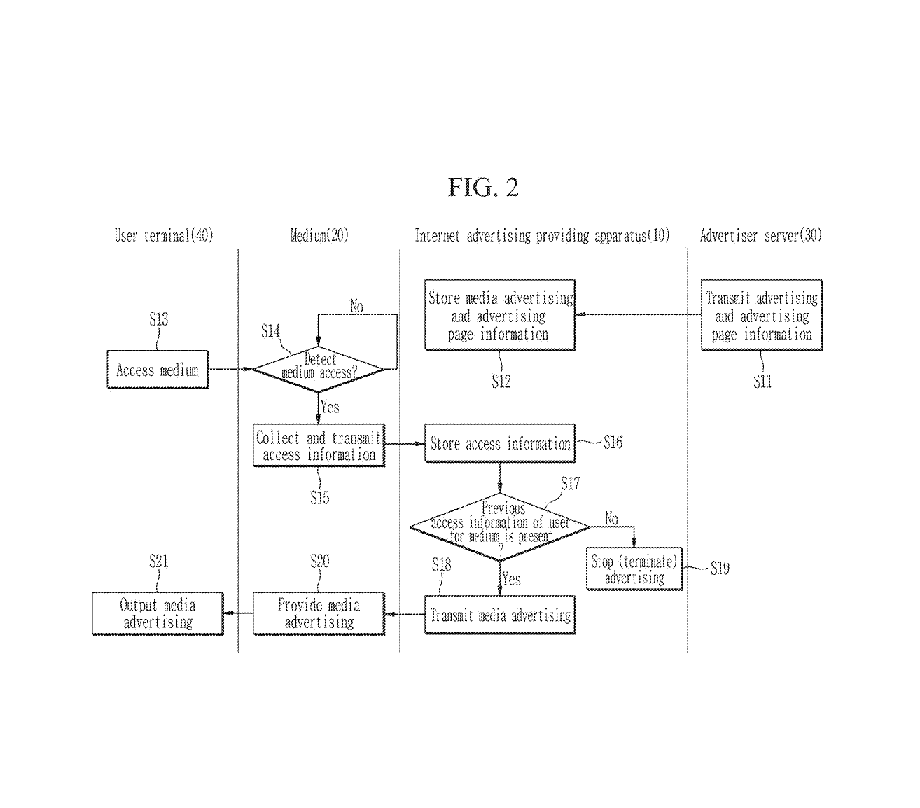

FIG. 2 is a diagram illustrating a media advertising providing method according to an exemplary embodiment of the present invention.

First, the advertiser server 30 transmits a plurality of media advertising and advertising page information to the Internet advertising providing apparatus 10 (S11), and the Internet advertising providing apparatus 10 stores the media advertising and the advertising page information transmitted from the advertiser server 30 in the advertising information DB 19 (S12).

Then, when a user accesses the medium 20 via the user terminal 40 (S13), the medium 20 detects the access of the user (S14), and collects user access information and transmits the collected user access information to the Internet advertising providing apparatus 10 (S15).

Then, the Internet advertising providing apparatus 10 stores the user access information transmitted by the access information collecting unit 11 in operation S15 in the user information DB 17 (S16).

Then, the Internet advertising providing apparatus 10 searches for a previous access of the user for the medium 20 based on the user access information via the user determining unit 12 (S17), and determines whether to transmit advertising according to a result of the search. Particularly, when an access history for the currently accessing medium or other media of the user is confirmed, the Internet advertising providing apparatus 10 determines that the user wants the advertising.

When it is determined that the user wants the advertising in operation S17, the Internet advertising providing apparatus 10 transmits the media advertising via the advertising transmitting unit 16 (S18). In this case, in operation S18, the Internet advertising providing apparatus 10 may transmit the corresponding media advertising to the user based on the user access information collected by the access information collecting unit 11 and the user movement information collected by the movement information collecting unit 13 or the combined information generated by the user analyzing unit 14.

When it is determined that the user does not want the advertising in operation S17, the Internet advertising providing apparatus 10 does not transmit the media advertising (S19).

Then, the medium 20 provides the user terminal 40 with the media advertising transmitted in operation S18 (S20), and the user terminal 40 outputs the media advertising (S21).

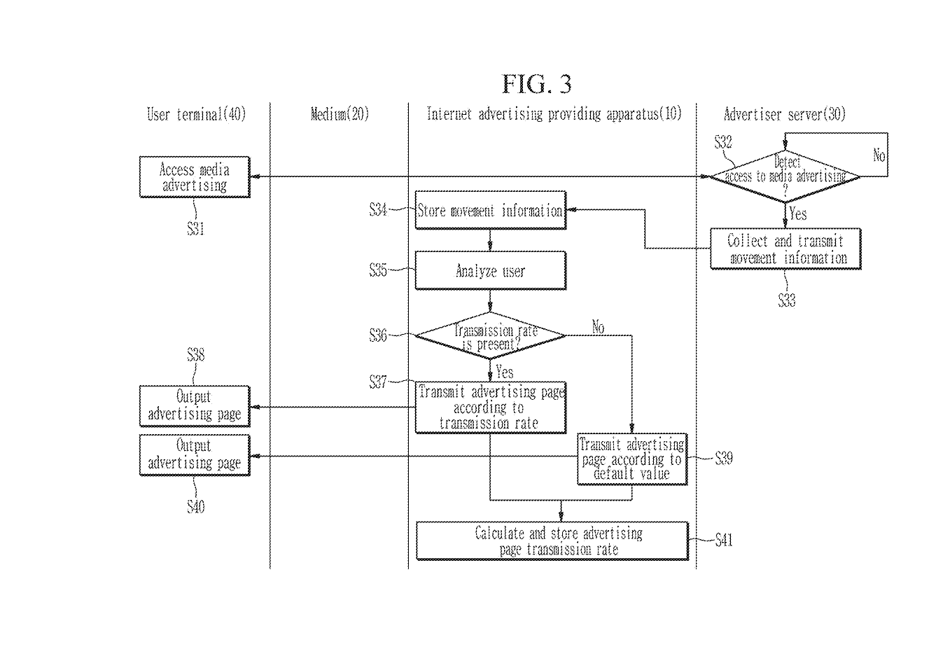

FIG. 3 is a diagram illustrating an advertising page providing method according to an exemplary embodiment of the present invention.

When the media advertising is output to the user terminal 40 through operation S21 of FIG. 2, the user accesses the media advertising (that is, views an advertising page) via the user terminal 40 (S31), and the advertiser server 30 detects the access to the media advertising (S32), collects the user movement information, and transmits the collected user movement information to the Internet advertising providing apparatus 10 (S33).

Then, the Internet advertising providing apparatus 10 stores the user movement information transmitted by the movement access information collecting unit 13 in operation S33 in the user information DB 17 (S34).

Then, the Internet advertising providing apparatus 10 generates combined information including the user access information and the user movement information via the user analyzing unit 14, and analyzes a tendency of the user based on the combined information and stores the analyzed tendency of the user in the combined information DB 18 (S35). In this case, the result of the analysis of the tendency of the user may include one or more of a user's action, an access keyword, an advertising effect based on an advertising page viewed by the user, an advertising page having the highest advertising effect, and an advertising page having the lowest advertising effect.

Then, the Internet advertising providing apparatus 10 searches for whether an advertising page transmission rate of the user is present via the user determining unit 12 (S36).

As a result of the search in operation S36, when the advertising page transmission rate of the user is present, the Internet advertising providing apparatus 10 transmits an advertising page to the user terminal 40 according to the advertising page transmission rate of the user via the advertising transmitting unit 16 (S37).

As the result of the search in operation S42, when the advertising page transmission rate of the user is not present, the Internet advertising providing apparatus 10 transmits an advertising page to the user terminal 40 according to the default value via the advertising transmitting unit 16 (S39).

The user terminal 40 outputs the advertising page provided via the Internet advertising providing apparatus 10 (S38 and S40).

Then the Internet advertising providing apparatus 10 calculates an advertising page transmission rate based on the result of the analysis of the tendency of the user of operation S35 via the advertising page transmission rate calculating unit 15 and stores the calculated advertising page transmission rate in the combined information DB 18 (S41). In this case, as a result of the search in operation S36, when the advertising page transmission rate of the user is present, the Internet advertising providing apparatus 10 updates the advertising page transmission rate stored in the combined information DB 18 to the advertising page transmission rate calculated in operation S41.

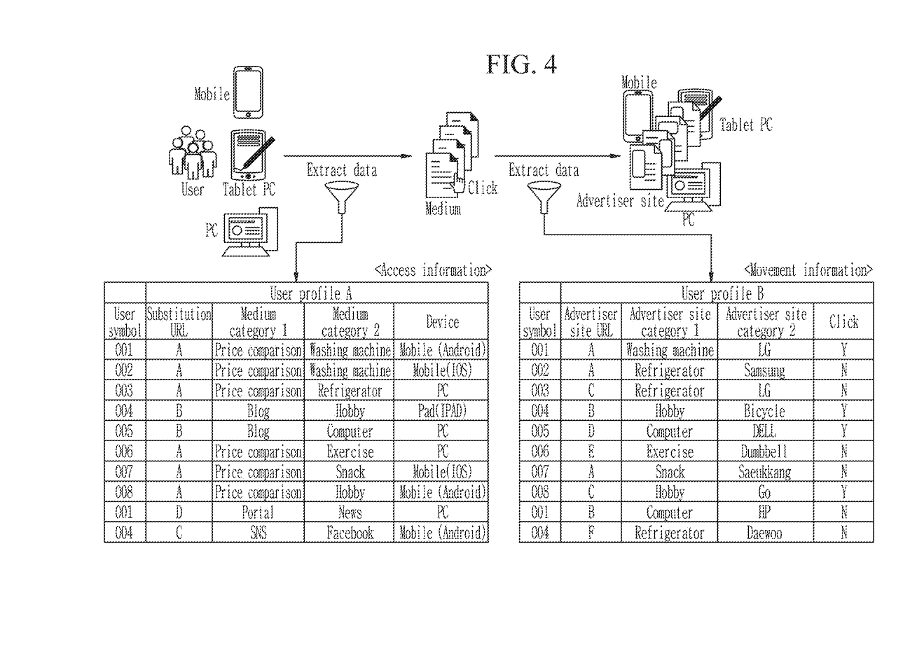

FIG. 4 is a diagram illustrating an example of access information and movement information according to the exemplary embodiment of the present invention.

Referring to FIG. 4, when the medium detects an access of the user, the medium 20 collects user access information including an medium URL, medium category 1, medium category 2, a device, and the like and transmits the collected user access information to the Internet advertising providing apparatus 10 in operation S15 of FIG. 2.

Further, when the user access the media advertising (that is, views the advertising page), the advertiser server 30 collects user movement information including an advertiser site URL, advertiser site category 1, advertiser site category 2, whether the user clicks or not, and the like for the advertising page provided via the user terminal 40 and transmits the collected user movement information to the Internet advertising providing apparatus 10 in operation S33 of FIG. 3.

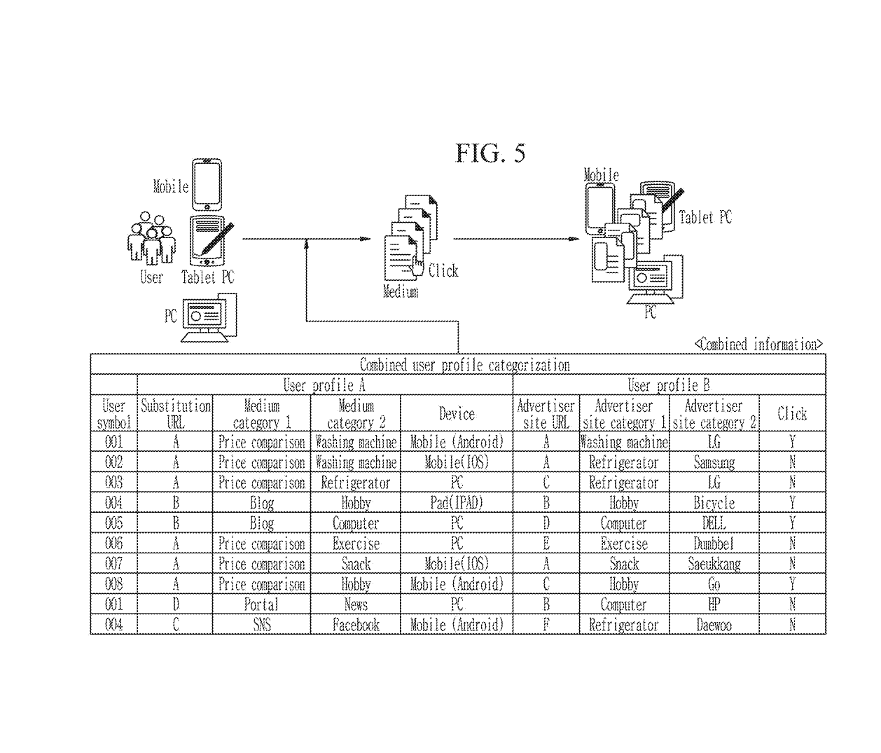

FIG. 5 is a diagram illustrating an example of combined information according to the exemplary embodiment of the present invention.

Referring to FIG. 5, to the Internet advertising providing apparatus 10 generates combined information including the user access information and the user movement information disclosed in FIG. 4 via the user analyzing unit 14 in operation S35 of FIG. 3.

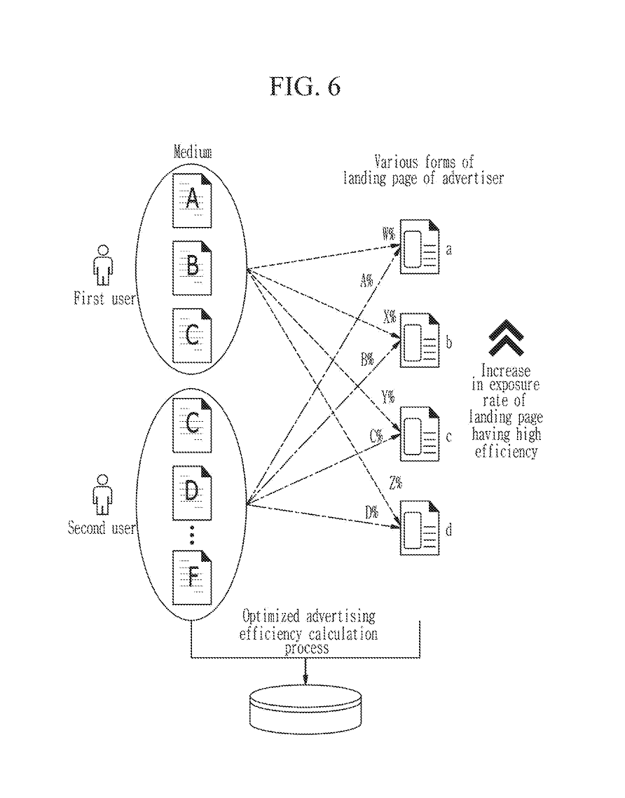

FIG. 6 is a diagram illustrating an example of an advertising page transmission rate according to the exemplary embodiment of the present invention.

FIG. 6 indicates an optimum advertising page transmission rate based on a user (a first user and a second user).

Referring to FIG. 6, when there are advertising pages a, b, c, and d corresponding to one keyword, advertising page-based transmission rates of the first user and the second user are W:X:Y:Z and A:B:C:D, respectively. In this case, W:X:Y:Z and A:B:C:D are the advertising page transmission rates optimized to the first user and the second user when the advertising page provided from the advertiser server 30 is provided to the first user and the second user.

That is, a transmission rate of an advertising page having high advertising efficiency to each user is high, and a transmission rate of an advertising page having low advertising efficiency to each user is low. In this case, the advertising page having high advertising efficiency to the user may be an advertising page which has the large number of times of previous view of the user, includes an interest keyword of the user, or corresponds to a user profile under a predetermined reference.

When the advertising page transmission rate of the first user is W>X>Y>Z, advertising page a having the highest advertising efficiency may be transmitted the first most to the first user terminal, advertising page b having the next highest advertising efficiency may be transmitted the second most to the first user terminal, advertising page c having the next highest advertising efficiency may be transmitted the third most to the first user terminal, and advertising page d having the lowest advertising efficiency may be least transmitted to the first user terminal.

According to the exemplary embodiment of the present invention, it is possible to calculate an advertising page transmission rate optimized to a user and provide the user with an advertising page by combining user access information for Internet media advertising and user movement information for an advertising page and analyzing the user.

According to the exemplary embodiment of the present invention, when a user accesses an Internet medium, media advertising is selectively provided based on one or more elements of pre-stored user access information, user movement information, and combined information, thereby improving advertising efficiency,

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. An apparatus for providing Internet advertising, the apparatus being connected with a medium, an advertiser server, and a user terminal via a wired/wireless communication network, the apparatus comprising:
an access information collecting unit which collects access information about a user for the medium;
a movement information collecting unit which collects movement information about the user for one or more advertising pages provided from the advertiser server;
a user analyzing unit which analyses a tendency of the user based on the access information and the movement information;
an advertising page transmission rate calculating unit which calculates an advertising page transmission rate based on a result of the analysis of the tendency of the user; and
an advertising transmitting unit which transmits the one or more advertising pages to the user terminal based on the advertising page transmission rate.

2. The apparatus of claim 1, further comprising:
a user determining unit which searches for an access history of the user for the medium based on the access information, and determines that the user wants media advertising when the access history of the user for the medium is present,
wherein the advertising transmitting unit transmits the media advertising when the user determining unit determines that the user wants the media advertising.

3. The apparatus of claim 1, wherein:
the access information includes one or more elements of information among a cookie, an Internet protocol(IP), and a user terminal identification (ID), and
the movement information includes one or more elements of information about a view order within the one or more advertising pages, the number of times of view based on an advertising page, a view time zone, and a view continuous time.

4. The apparatus of claim 1, wherein:
the result of the analysis of the tendency of the user includes one or more of an action of the user, an access keyword, an advertising effect based on an advertising page viewed by user, an advertising page having the highest advertising effect, and an advertising page having the lowest advertising effect.

5. A method of providing Internet advertising, the method being connected with a medium, an advertiser server, and a user terminal via a wired/wireless communication network, the method comprising:
collecting access information about a user for the medium;
searching an access history of the user for the medium based on the access information, and determining that the user wants media advertising when the access history of the user for the medium is present; and
transmitting the media advertising when it is determined that the user wants the media advertising in the determining of the user.

6. A method of providing Internet advertising, the method being connected with a medium, an advertiser server, and a user terminal via a wired/wireless communication network, the method comprising:
collecting access information about a user for the medium;
collecting movement information about the user for one or more advertising pages provided from the advertiser server;
analyzing a tendency of the user based on the access information and the movement information;
calculating an advertising page transmission rate based on a result of the analysis of the tendency of the user; and
transmitting the one or more advertising pages to the user terminal based on the advertising page transmission rate.

7. The method of claim 6, further comprising:
searching for an access history of the user for the medium based on the access information; and
determining that the user wants media advertising when the access history of the user for the medium is present,
wherein in the determining of the user, the media advertising is transmitted when it is determined that the user wants the media advertising.

8. The method of claim 6, wherein:
the result of the analysis of the tendency of the user includes one or more of an action of the user, an access keyword, an advertising effect based on an advertising page viewed by the user, an advertising page having the highest advertising effect, and an advertising page having the lowest advertising effect.

9. The method of claim 5, wherein:
the access information includes one or more elements of information among a cookie, an Internet protocol (IP), and a user terminal identification (ID), and
the movement information includes one or more elements of information about a view order within the one or more advertising pages, the number of times of view based on an advertising page, a view time zone, and a view continuous time.

10. The method of claim 6, wherein:
the access information includes one or more elements of information among a cookie, an Internet protocol (IP), and a user terminal identification (ID), and
the movement information includes one or more elements of information about a view order within the one or more advertising pages, the number of times of view based on an advertising page, a view time zone, and a view continuous time.
